(19) United States
(12) Patent Application Publication
(10) Pub. No.: US 2024/0076498 A1
(43) Pub. Date: Mar. 7, 2024

(54) ASPHALT BINDERS AND RELATED METHODS AND USES

(71) Applicant: InnoTech Alberta Inc., Edmonton (CA)

(72) Inventors: Kasra Nikooyeh, Edmonton (CA); Thomas Kaminski, Edmonton (CA); Richard McFarlane, Edmonton (CA); Haibo Huang, Edmonton (CA); John Bleile, Edmonton (CA); James Donald, Edmonton (CA); Monika Dul, Edmonton (CA)

(73) Assignee: InnoTech Alberta Inc., Edmonton, AB (CA)

(21) Appl. No.: 18/462,066

(22) Filed: Sep. 6, 2023

Related U.S. Application Data
(60) Provisional application No. 63/374,813, filed on Sep. 7, 2022.

(51) Int. Cl. C08L 95/00

(52) U.S. Cl. CPC C08L 95/00; C08L 2555/10; C08L 2555/34

(57) ABSTRACT

Asphalt binders and related methods and uses are provided. In some embodiments, the asphalt binder is produced by: providing a high-asphaltene content petroleum feedstock; performing solvent deasphalting on the feedstock to produce a partially deasphalted oil and an asphaltene-rich residue; and collecting the partially deasphalted oil (DAO). The high-asphaltene content petroleum feedstock may comprise residue from vacuum distillation or flash separation of extra heavy oil or bitumen, or recycled asphalt. The DAO may itself be used as the asphalt binder or may be a component of a blend with the original feedstock. Asphalt binders may also be produced by blending residue and heavy distillate produced from vacuum distillation or flash separation, with DAO or the asphaltene-rich residue of the solvent deasphalting process. The disclosed methods allow for production of asphalt binders of a wide variety of performance grades.

### CROSS REFERENCE TO RELATED APPLICATION

The present application claims priority to U.S. Provisional Patent Application No. 63/374,813 filed Sep. 7, 2022, the entire contents of which are incorporated herein by reference.

### TECHNICAL FIELD

The present disclosure relates to asphalt binders. More particularly, the present disclosure relates to asphalt binders produced from high viscosity and asphaltene content petroleum feedstocks and related methods and uses.

### BACKGROUND

Asphalt binder is an inexpensive, waterproof and thermoplastic adhesive that is used to hold paved roads together. Asphalt binders are commonly derived from petroleum refining residues; however, often they must be processed from their original form to meet certain grades and specifications set out by the transportation industry. Performance is typically measured in relation to temperature as the road material must be able to withstand a wide range of temperatures.

The residue or “bottoms” of vacuum distillation of light and conventional heavy oils may itself be used as an asphalt binder or the vacuum bottoms may be subjected to solvent deasphalting to improve the asphalt binder performance. Solvent deasphalting may involve contacting a crude feedstock (e.g., atmospheric bottoms, vacuum bottoms, etc.) with an n-alkane precipitating solvent, thereby producing a light deasphalted product and a heavy asphaltene-rich residue. The light deasphalted product can be further processed to produce other high-value light fraction products, while the heavy asphaltene-rich residue can be used as an asphalt binder (commonly referred to as “solvent deasphalted asphalt”). Solvent deasphalted asphalt tends to display better performance at high temperatures than the original feed.

The heavier the oil, the greater the vacuum bottom fraction. Vacuum distillation of extra heavy oil or natural bitumen typically produces 40-60% vacuum bottoms which are less fluid and more rigid than light and conventional heavy oil vacuum bottoms. Bitumen vacuum bottoms also have a high asphaltene content and may be too brittle to be used as an asphalt binder as they may not meet the low temperature elasticity requirements. As a result, bitumen vacuum bottoms are typically only sent to cokers or hydrotreaters to produce synthetic crude, which employs costly processes to produce higher value fractions from the heavy feed material.

### SUMMARY

In one aspect, there is provided a method for producing an asphalt binder, comprising: providing a high-asphaltene content petroleum feedstock; performing solvent deasphalting on the high-asphaltene content petroleum feedstock to produce a partially deasphalted oil and an asphaltene-rich residue; and collecting the partially deasphalted oil for use in the asphalt binder, wherein the asphalt binder at least partially comprises the partially deasphalted oil.

In some embodiments, the method further comprises dividing the high-asphaltene content petroleum feedstock into a first portion and a second portion, wherein the solvent deasphalting is performed on the first portion to produce the partially deasphalted oil; and blending the partially deasphalted oil with the second portion of the feedstock to produce the asphalt binder.

In some embodiments, the partially deasphalted oil is blended with the second portion of the feedstock such that the asphalt binder comprises between about 10% and about 90% partially deasphalted oil.

In some embodiments, the high-asphaltene content petroleum feedstock comprises residue from vacuum distillation or flash separation of a crude petroleum feedstock.

In some embodiments, providing the high-asphaltene content petroleum feedstock comprises: providing a crude petroleum feedstock; selecting a vacuum distillation cut temperature for a vacuum residue based on a desired viscosity of the vacuum residue; subjecting the crude petroleum feedstock to vacuum distillation at the selected vacuum distillation cut temperature; collecting the vacuum residue for use as the high-asphaltene content petroleum feedstock.

In some embodiments, the selected vacuum distillation cut temperature is an atmospheric equivalent temperature of between about 400° C. and about 550° C.

In some embodiments, the method further comprises blending the vacuum residue with a heavy distillate to adjust the viscosity of the vacuum residue.

In some embodiments, the crude petroleum feedstock comprises bitumen or extra heavy oil.

In some embodiments, the crude petroleum feedstock comprises recycled asphalt.

In some embodiments, the method further comprises collecting a fraction of the asphaltene-rich residue for use in carbon fiber production.

In another aspect, there is provided a method for producing an asphalt binder, comprising: providing a crude petroleum feedstock; subjecting the crude petroleum feedstock to vacuum distillation or flash separation to produce a heavy distillate and a residue; dividing the residue into a first portion and a second portion; performing solvent deasphalting on the first portion of the residue to produce a partially deasphalted oil and an asphaltene-rich residue; and blending the second portion of the residue with the heavy distillate and one of the partially deasphalted oil and the asphaltene-rich residue.

In some embodiments, the heavy distillate has an atmospheric equivalent boiling temperature between about 350° C. and about 550° C. and the residue has an atmospheric equivalent boiling temperature greater than the heavy distillate.

In some embodiments, the method further comprises selecting a composition of the asphalt binder to achieve a desired grade using an empirical model that predicts high temperature grade and low temperature grade based on: measuring viscosities of each of the residue, the heavy distillate, and at least one of the partially deasphalted oil and the asphaltene-rich residue; correlating the measured viscosities with high temperature grade for a given blend; and correlating high temperature grade with low temperature grade.

In some embodiments, the residue is further divided into a third portion, and the blending step comprises: blending the second portion of the residue with a first portion of the heavy distillate and the partially deasphalted oil to produce a first asphalt binder; and blending the third portion of the residue with a second portion of the heavy distillate and the asphaltene-rich residue to produce a second asphalt binder.

In some embodiments, the crude petroleum feedstock comprises bitumen or extra heavy oil.

In some embodiments, the crude petroleum feedstock comprises recycled asphalt.

In some embodiments, the method further comprises collecting a fraction of the asphaltene-rich residue for use in carbon fiber production.

In another aspect, there is provided an asphalt binder comprising: a first portion of a residue produced by vacuum distillation or flash separation of a crude petroleum feedstock; a heavy distillate produced by the vacuum distillation or flash separation of the crude petroleum feedstock; and a partially deasphalted oil or an asphaltene-rich residue produced by solvent deasphalting of a second portion of the residue.

In some embodiments, the crude petroleum feedstock comprises bitumen or extra heavy oil.

In some embodiments, the crude petroleum feedstock comprises recycled asphalt.

Other aspects and features of the present disclosure will become apparent to those ordinarily skilled in the art, upon review of the following description of specific embodiments of the disclosure.

### BRIEF DESCRIPTION OF THE DRAWINGS

Some aspects of the disclosure will now be described in greater detail with reference to the accompanying drawings. In the drawings:

FIG. 1 is a flowchart of a method for producing an asphalt binder, according to some embodiments;

FIG. 2 is a flowchart of another example method, according to some embodiments;

FIG. 3 is a flowchart of an example method for producing a feedstock for the methods of FIGS. 1 and 2;

FIG. 4 is a functional block diagram of a system that may implement the methods of FIGS. 1 to 3, according to some embodiments;

FIG. 5 is a flowchart of another example method for producing asphalt binders, according to some embodiments;

FIG. 6A is a functional block diagram of a system that may implement the method of FIG. 5, according to some embodiments;

FIG. 6B is a functional block diagram of a pair of mixing devices of the system of FIG. 6A;

FIG. 7 is a functional block diagram of another system that may implement the method of FIG. 5, according to some embodiments;

FIG. 8 is a graph showing a vacuum distillation curve of bitumen used to produce a feedstock for production of asphalt binder samples in experimental studies;

FIG. 9 is a graph showing asphaltene content versus solvent-to-oil ratio for deasphalted oil (DAO) samples produced by solvent deasphalting of the feedstock of FIG. 8 at 25° C. or at 120° C. in the laboratory;

FIG. 10 is a graph showing the natural logarithm viscosity of various asphalt binder samples measured at 135° C. versus the asphaltene content of the sample. The dashed line represents a linear fit to the data;

FIG. 11 is a graph showing high failure temperature of various asphalt binder samples plotted versus the asphaltene content of the sample. The dashed line represents a linear fit to the data;

FIG. 12 is a graph showing low failure temperature of various asphalt binder samples plotted versus the asphaltene content of the sample;

FIG. 13 is a graph showing temperature range (high failure temperature minus low failure temperature) of various asphalt binder samples plotted versus the high failure temperature of the sample; and

FIG. 14 is a performance grade table of commonly marketed asphalt binders, indicating asphalt binder grades obtained in experimental studies using the feedstock of FIG. 8 and grades predicted to be obtainable from the same feedstock.

### DETAILED DESCRIPTION

Generally, the present disclosure provides asphalt binders produced from petroleum feedstocks and related methods and uses. In some embodiments, the feedstock comprises vacuum residue from extra heavy oil or bitumen and the asphalt binders are produced by solvent deasphalting the feedstock and collecting the resulting partially deasphalted oil. The partially deasphalted oil may itself be used as an asphalt binder or may be used as part of a blend with the original feedstock.

As used herein the terms “a”, “an”, and “the” may include plural referents unless the context clearly dictates otherwise.

As used herein, “upstream” and “downstream” refer to the direction of the flow of fluids through embodiments of the systems described herein. Under normal operating conditions, fluids flow from an upstream position to a downstream position.

As used herein, “asphalt binder” or “asphalt” refers to a material that can be used as the binder phase of an asphalt pavement.

As used herein, “petroleum feedstock” refers to crude oil and/or any substance produced or derived from crude oil. The petroleum feedstock may contain at least about 10% asphaltene content by weight. In some embodiments, the petroleum feedstock is a “high asphaltene content petroleum feedstock” with an asphaltene content of at least about 20%. High asphaltene content feedstocks generally have a viscosity greater than conventional crude oil vacuum residue that is typically used in asphalt binder production. A “crude” petroleum feedstock refers to a petroleum material that has not undergone substantial processing to remove asphaltenes and is inclusive of crude oil, extra-heavy crude oil, bitumen, diluted crude oil/bitumen (e.g., with diluent), as well as atmospheric distillation residue, and flash product after diluent removal.

“Extra heavy oil”, as used herein, refers to crude oil having a room temperature viscosity greater than 10,000 centipoise and an API gravity of 10° API or lower and is inclusive of bitumen. The term “bitumen” is used herein to refer to natural bitumen (e.g., the extra heavy oil extracted or produced from oil sands deposits). Refined bitumen is referred to herein as asphalt or asphalt binder. Extra heavy oil/bitumen may be recovered from a reservoir via a thermal oil recovery process such as SAGD (Steam Assisted Gravity Drainage), via surface extraction, or via any other suitable process.

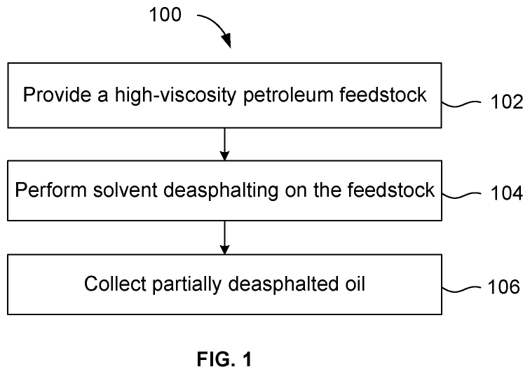

FIG. 1 is a flowchart of an example method 100 for producing an asphalt binder, according to some embodiments.

At block 102, a high-asphaltene content petroleum feedstock is provided. The term “provide” in this context means making, acquiring, or otherwise obtaining the feedstock.

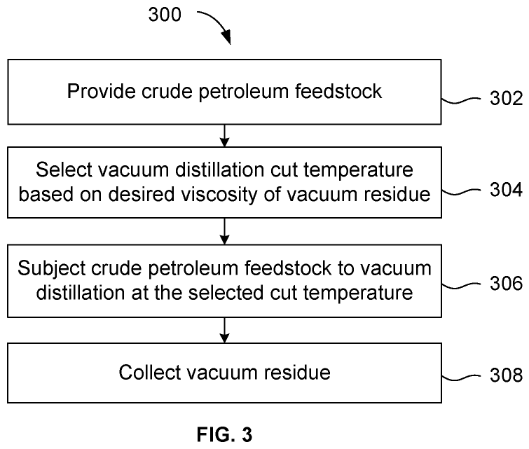

In some embodiments, the feedstock comprises vacuum residue or “bottoms” produced by vacuum distillation of a crude petroleum feedstock, such as extra heavy oil or bitumen. The extra heavy oil/bitumen may be subjected to vacuum distillation using any suitable procedure. In some embodiments, the oil/bitumen is distilled under vacuum at an atmospheric-equivalent temperature of between about 300° C. and about 550° C., or between about 400° C. and about 550° C., or more particularly between about 500° C. and about 540° C. As one example, the oil/bitumen may be distilled under vacuum at an atmospheric-equivalent temperature of about 524° C. In other embodiments, the oil/bitumen may be distilled at a lower temperature as discussed below with respect to the method 300 of FIG. 3. The vacuum bottoms are collected for use as a feedstock. The vacuum bottoms may account for at least about 30%, at least about 40%, or at least about 50% of the original extra heavy oil/bitumen. In some embodiments, the vacuum bottoms account for between about 40% and about 60%, or between about 40% and about 50%, or approximately 50% of the original extra heavy oil/bitumen.

In other embodiments, the feedstock comprises residue/bottoms produced from single-stage or multi-stage flash separation (“flashing”) of a crude petroleum feedstock with or without injection of steam or a non-condensable carrier gas. The flash residue may have a similar viscosity and asphaltene content as vacuum residue.

The vacuum or flash residue may have an asphaltene content of at least about 20%, at least about 25%, or at least about 30% (by weight). In some embodiments, the asphaltene content is between about 10% and about 50%, or between about 20% and about 40%, or approximately 30% (by weight).

In other embodiments, the feedstock comprises recycled asphalt. The term “recycled asphalt” as used herein refers to asphalt binder reclaimed from asphalt pavement, asphalt shingles, or the like. In some embodiments, the recycled asphalt is extracted using a solvent, followed by removal of the solvent. The solvent may comprise, for example, a polar, aromatic, or aliphatic solvent. If an aliphatic solvent is used, the resulting solvent-extracted recycled asphalt may have a relatively low asphaltene content compared to that recovered using polar or aromatic solvents.

In yet other embodiments, the feedstock is any other suitable high viscosity and high asphaltene content petroleum material.

At block 104, solvent deasphalting is performed on the feedstock. Solvent deasphalting comprises combining the feedstock with a suitable solvent. The feedstock may be combined with the solvent by mixing, stirring, shaking, inverting, or any other suitable means. The feedstock may be combined with at least about 1 g of solvent, at least about 2 g of solvent, or at least about 2.5 g of solvent per gram of feedstock (i.e., a feedstock-to-solvent ratio of at least about 1:1, 1:2, or 1:2.5, respectively). In some embodiments, the feedstock is combined with between about 1 g and about 10 g of solvent per gram of feedstock (i.e., 1:1 to 1:10 feedstock-to-solvent ratio) or, more particularly, between about 2 g and about 5 g of solvent per gram of feedstock (i.e., 1:2 to 1:5 feedstock-to-solvent ratio).

The solvent is a suitable solvent that can lead to heavy phase separation of the feedstock. The solvent may have a Hildebrand solubility parameter of between about 13 and about 16 MPa^{1/2}. In some embodiments, the solvent comprises at least one aliphatic hydrocarbon. In some embodiments, the aliphatic hydrocarbon is a paraffinic hydrocarbon. Non-limiting examples of paraffinic hydrocarbons include propane, butane, n-pentane, and isopentane. In some embodiments, the solvent may be a mixture of two or more paraffinic hydrocarbons. Alternatively, the solvent may comprise one or more non-aliphatic hydrocarbons that can lead to a heavy phase separation upon mixing with the feedstock. For example, the non-aliphatic hydrocarbon solvent may comprise acetone when the feedstock is bitumen.

The feedstock and solvent mixture may then be allowed to separate into a lighter, partially deasphalted phase and a heavy, asphaltene-rich phase. The lighter phase may be substantially liquid and the heavy phase may be a mixture of liquid and solids, including asphaltenes. At higher temperatures, the asphaltenes may be in liquid form and the heavy phase may be substantially liquid. Hereafter, the lighter phase may also be referred to as “partially deasphalted oil” or simply “deasphalted oil” (DAO), although it will be understood that the oil is not fully deasphalted and some asphaltene content still remains. The heavy phase may also be referred to as “asphaltene-rich residue” or “deasphalting residue”.

The solvent deasphalting step may be performed in a suitable vessel such that the solids (i.e., asphaltenes) settle towards the bottom of the vessel. In some embodiments, the solvent deasphalting step is substantially continuous such that the feedstock/solvent mixture is continuously fed into the vessel and liquid and solids are continuously withdrawn. In these embodiments, the vessel is sized such that the vertical velocity of the liquid inside the vessel is lower than the settling velocity of the solids. The settling velocity of asphaltenes in the liquid may be between about 0.1 and about 200 mm/min, with higher temperature operations leading to higher velocities.

In other embodiments, the mixture may be left to settle in a vessel for a suitable period of time, followed by withdrawal of the liquid and solids. In these embodiments, the settling time may depend on the size and dimensions of the vessel and may range from a few minutes (e.g., 10-20 minutes), to a few hours (e.g., 8-12 hours) to 24 hours or more.

In some embodiments, cyclones, centrifuges, and/or other enhanced gravity methods and equipment may be used to assist in separation of the solids from the liquid during the solvent deasphalting process.

In some embodiments, solvent deasphalting is performed at room temperature. As used herein, “room temperature” or “ambient temperature” refers to a temperature of a temperature-controlled building or environment. For example, room temperature may be between about 15° C. and about 30° C. or between about 19° C. and about 25° C. In other embodiments, the feedstock/solvent mixture may be heated during solvent deasphalting. For example, the mixture may be heated to a temperature between room temperature and approximately 120° C. Temperatures higher than 120° C. may also be possible depending on the type of solvent and operating pressure used.

As demonstrated in the Examples below, solvent deasphalting of a high-asphaltene content feedstock (such as bitumen vacuum bottoms) may produce between about 50% and about 90% DAO and between about 10% and about 40% asphaltene-rich residue. In some embodiments, the DAO may have an asphaltene content between about 0.5% and about 20% (by weight), or more particularly between about 1% and about 5% (by weight). However, it will be understood that the percentages outside of these ranges are possible, depending on the nature of the feedstock and the conditions of the solvent deasphalting step.

At block 106, the partially deasphalted oil is collected. The DAO may be collected by decanting, withdrawing, or otherwise separating the lighter phase of the separated feedstock/solvent mixture from the heavy phase. Collecting the DAO may further comprise removing the solvent from the DAO. In some embodiments, the solvent is removed by evaporation, for example, by rotary evaporation. In other embodiments, the solvent may be removed by any other suitable means including, for example, single or multi-stage flashing, evaporation, distillation, or supercritical separation. It will be understood that, while the solvent may be substantially removed from the DAO, trace amounts of residual solvent may remain.

The DAO may then be used as an asphalt binder. The DAO alone may be used as the asphalt binder or may be used as part of a blend, as discussed in more detail below. In some embodiments, the DAO may be combined with any other suitable additive to form the final asphalt binder.

In some embodiments, the DAO is characterized prior to its use as an asphalt binder. Characterization of the DAO may include viscosity and density measurements or more broadly determining its asphalt binder performance grade (PG). The performance grade may be determined using the Superpave (Superior Performing Asphalt Pavements) system developed by the Strategic Highway Research Program (SHRP) in the United States, which has been adopted by all U.S. states and many countries around the world. The Superpave system uses a common battery of tests defined by the American Association of State Highway and Transportation Officials (AASHTO) to determine the maximum and minimum temperature at which the binder performs adequately. Performance grading is reported using two consecutive numbers XX-YY, where XX is the high performance temperature (in ° C.) and -YY is the low performance temperature (in minus ° C.). Asphalt binders having a PG XX-YY grading resist high temperature deformation at temperatures of XX° C. or lower and resist low temperature cracking at temperatures of −YY° C. or higher.

As described in the Examples below, embodiments of the asphalt binders produced by the method 100 were found to have a low temperature performance grade of at least about −10° C. or lower and a high temperature performance grade of at least about 40° C. or higher. In some embodiments, the binders display a temperature range (i.e., high failure temperature minus low failure temperature) of at least about 74° C. or between about 74° C. and about 92° C. However, it will be understood that these temperature ranges are examples only, and other asphalt binders produced by the method 100 may perform at higher and/or lower temperatures.

As also shown in the Examples below, a higher solvent-to-feedstock ratio during the solvent deasphalting step decreases the asphaltene content of the DAO and lowers the low temperature limit of the resulting asphalt binder. Therefore, in some embodiments, the solvent-to-feedstock ratio may be adjusted at block 104 to produce an asphalt binder with a desired low temperature performance and PG grade.

In some embodiments, the method 100 further comprises collecting the asphaltene-rich residue from the solvent deasphalting step. The asphaltene-rich residue may be further processed for downstream applications. In some embodiments, the residue is washed in single or multiple stages by mixing with fresh solvent, settling, and decanting the top liquid or using equipment suitable for washing solids (e.g., belt filters, log washers, etc.) to remove entrained bitumen or other petroleum feedstock. The resulting solids can be used as the feedstock for various applications including carbon fiber production, hydrogen and syngas generation, or for any other suitable application.

Other variations of the method 100 are also possible. In alternative embodiments, the feedstock may be a crude petroleum feedstock and, after solvent deasphalting, the DAO may be collected and then subjected to vacuum distillation to produce a final product for use as an asphalt binder. For example, the crude petroleum feedstock in these embodiments may comprise bitumen froth from oil sands surface extraction and the solvent deasphalting step may be a paraffinic froth treatment step in which the bitumen froth is combined with a paraffinic solvent and a portion of the asphaltenes are precipitated. The partially deasphalted product of the paraffinic froth treatment may then be subjected to vacuum distillation to produce the final DAO for use as an asphalt binder.

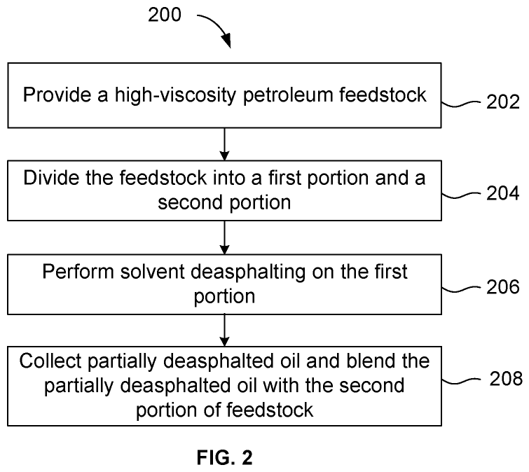

FIG. 2 is a flowchart of another example method 200 for producing an asphalt binder, according to some embodiments.

At block 202, a high-asphaltene content petroleum feedstock is provided. The feedstock may be any of the feedstocks described above for the method 100. At block 204, the feedstock is divided into a first portion and a second portion. The first and second portion may each be any suitable percentage of the original feedstock.

At block 206, solvent deasphalting is performed on the first portion of the feedstock. The steps at block 206 may be similar to the steps at block 104 of the method 100, as described above. The solvent deasphalting step will produce a partially deasphalted oil and an asphaltene-rich residue.

At block 208, the partially deasphalted oil is collected and blended with the second portion of the feedstock. The DAO may be collected in a similar manner to the steps of block 106 of the method 100, as described above. The DAO and the second portion of the feedstock may be blended by combining the DAO and the second portion by mixing, stirring, shaking, inverting, or any other suitable means. The DAO/feedstock blend may comprise between about 1% and about 99% DAO and between about 1% and 99% feedstock. In some embodiments, the blend comprises between about 10% and about 90%, between about 20% and about 80% DAO, between about 25% and about 75% DAO, or between about 30% and about 70% DAO, with the remainder being feedstock. In other embodiments, such as discussed above with respect to the method 100, the asphalt binder is 100% DAO.

In some embodiments, the ratio of DAO to feedstock is based on a desired asphaltene content of the final blend. Addition of more feedstock will increase the asphaltene content, and thus the viscosity, of the blend. In some embodiments, the asphaltene content of the blend is between about 5% and about 30%, between about 10% and about 25%.

Therefore, the asphaltene content of the asphalt binder may be adjusted by two different means: 1) by adjusting the solvent-to-feedstock ratio during the solvent deasphalting step as discussed above; and/or 2) by adjusting the proportion of DAO and feedstock in a blend. For example, a DAO may be produced with lower than desired asphaltene content (using a higher solvent-to-feedstock ratio) and then blended with the original feedstock to raise the asphaltene content to the desired level.

The DAO/feedstock blend may be used as an asphalt binder. In some embodiments, the blend may be combined with any other suitable additive to form the final asphalt binder. In some embodiments, the blend is characterized prior to its use as an asphalt binder, including by determining its performance grade, as described above for the asphalt binder produced by the method 100.

As described in the Examples below, embodiments of the blended asphalt binders produced by the method 200 were found to have low temperature performance grade of at least about −10° C. or lower and a high temperature performance grade of at least about 40° C. or higher. In some embodiments, the binders display a temperature range (i.e., high failure temperature minus low failure temperature) of at least about 80° C. or between about 80° C. and about 95° C. However, it will be understood that these temperature ranges and PG grades are examples only, and other asphalt binders produced by the method 200 may perform outside of these ranges.

Therefore, the asphalt binders produced by the methods 100 and 200 are able to meet the specifications required for pavement asphalt in a variety of different climates, in contrast to the original feedstock (e.g., bitumen vacuum bottoms) that is typically too brittle to be used as an asphalt binder. The disclosed asphalt binders may thus provide a high-value product from low-value feedstock without expensive processing steps or equipment.

FIG. 3 is a flowchart of an example method 300 for producing a petroleum feedstock, according to some embodiments. The method 300 may proceed the method 100 or 200 as described above.

At block 302, a crude petroleum feedstock is provided. In some embodiments, the crude petroleum feedstock is extra-heavy crude oil, bitumen, or any of the other crude petroleum feedstock described above.

At block 304, a distillation cut temperature is selected based on a desired property of the vacuum residue. As used herein, “cut temperature” or “cut point” refers to the temperature that defines the boundary between the distillate and the vacuum residue. In some embodiments, the distillation cut temperature is selected based on a desired viscosity of the vacuum residue. The cut temperature may be selected empirically or may be a pre-determined temperature based on previous data and/or modelling.

In some embodiments, the distillation cut temperature may be lower than conventional vacuum distillation cut temperatures in order to increase the proportion of lighter boiling point components in the vacuum residue and, thus, reduce the vacuum residue's viscosity. In some embodiments, the distillation cut temperature is less than about 540° C., less than about 525° C. (or 524° C.), or less than about 500° C. (atmospheric equivalent temperature). In some embodiments, the cut temperature is between about 400° C. and about 550° C., between about 420° C. and about 525° C. (or 524° C.) (atmospheric equivalent temperature). In other embodiments, a higher distillation cut temperature may be selected to raise the viscosity of the vacuum residue. The desired cut may be achieved by adjusting the temperature and/or the level of vacuum of the vacuum distillation process. Alternatively, or additionally, the desired cut may be achieved using steam or inert gas stripping.

The minimum distillation cut temperature may be limited by the flash point of the resulting asphalt binder. If the distillation temperature is too low, the binder would have a flash point below 230° C., which may not be acceptable for any grade of asphalt binder. The minimum distillation temperature may also be limited by the maximum allowable weight loss (<0.5%) of the resulting asphalt binder upon heat treatment during ageing at 160° C. (in a Rolling Thin-Film Oven).

The maximum temperature of the feed and products for the vacuum distillation process may be selected so as not to exceed the thermal cracking threshold to ensure the products (including produced asphaltenes) remain free of coke and cracked components.

At block 306, the crude petroleum feedstock is subjected to vacuum distillation using the selected cut temperature. Vacuum distillation produces a distillate and a vacuum residue. Vacuum distillation may be performed in any suitable distillation unit using any suitable procedure.

At block 308, the vacuum residue is collected. The lower the distillation cut temperature, the higher proportion of vacuum residue that is produced compared to the distillate. In embodiments in which the distillation cut temperature is between about 420° C. and about 500° C., about 60% to 75% vacuum residue may be produced (and about 25% to 40% distillate), compared to about 50% to 60% vacuum residues (and about 40% to 50% distillate) produced by vacuum distillation at conventional cut temperatures (e.g., 524° C.).

In some embodiments, the viscosity of the vacuum residue may be adjusted to a desired level. For example, the viscosity of the residue cut may be adjusted by adding a heavy distillate fraction (to lower viscosity) or adding a portion of residue from distillation at a higher temperature (to raise viscosity).

In some embodiments, the vacuum residue may then be used as the high-asphaltene content petroleum feedstock for the method 100 or 200. By adjusting the distillation cut temperature at block 304 (and/or addition of distillate or residue), feedstocks of varying viscosities can be produced, resulting in asphalt binders of varying properties. Feedstocks produced at lower cut temperatures may result in asphalt binders having lower viscosity and higher elasticity, thereby lowering their low temperature limit and producing asphalt binders more suitable for colder environments. Adjusting the cut point may also affect the width of the temperature range between the low temperature limit and the high temperature limit. Asphalt binders with wider temperature ranges generally have higher commercial values.

In other embodiments, the vacuum residue may be used as the residue at block 508 of the method 500, as described in more detail below. In these embodiments, the residue may or may not be a “high-asphaltene content” feedstock as defined above.

In some embodiments, the method 300 further comprises collecting the distillate for use and/or downstream processing. In some embodiments, at least a fraction of the distillate may be used to adjust the viscosity of the vacuum residue as discussed above. Alternatively, or additionally, the distillate or a fraction thereof may be condensed and used as a substitute for diluent for blending with sales bitumen or extra heavy oil to meet pipeline specification. For example, distillate produced from a bitumen feedstock may have a density of about 0.9 to 0.95 g/cm³ and can therefore decrease the viscosity and density of bitumen significantly upon blending. The distillate may also lower the sulfur content of the diluted bitumen product. Thus, the method 300 may be used to produce two high-value products: asphalt binder (via the methods 100/200) and a diluent substitute.

Other variations are also possible. In some embodiments, the vacuum bottoms are subjected to mild oxidation after the steps of block 308. In other embodiments, the vacuum distillation steps may be performed at standard temperatures and the vacuum bottoms may then be oxidized. The mildly oxidized vacuum bottoms may then be used as the feedstock in the method 100 to produce deasphalted “oil after oxidation”. Mild oxidation may increase the high failure temperature of the resulting asphalt binder without significantly affecting low failure temperature.

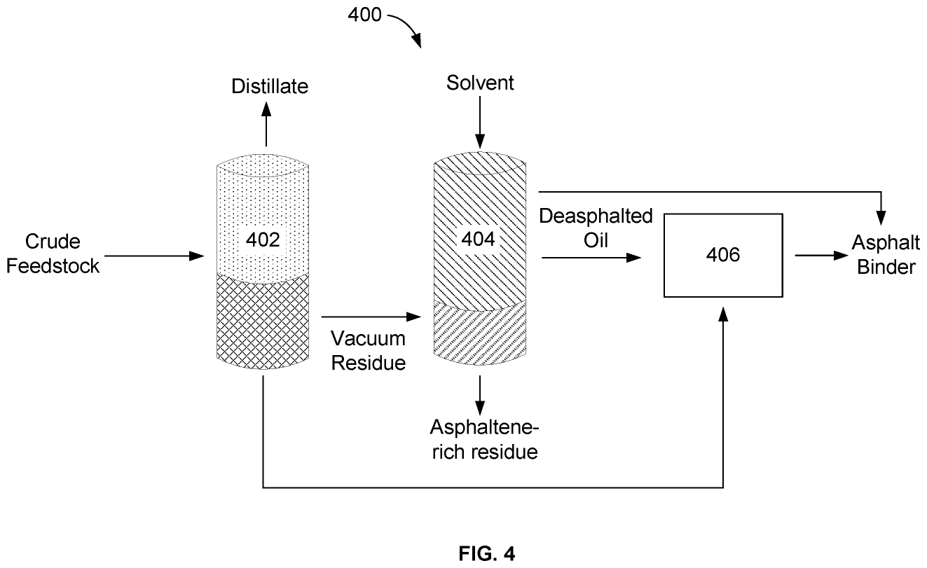

FIG. 4 is a functional block diagram of an example system 400 that may implement the method 300. The system 400 may comprise a vacuum distillation unit 402, a solvent deasphalting unit 404, and a mixing unit 406. Each of the units 402, 404, and 406 may comprise one or more pieces of equipment. In some embodiments, the units 402, 404, and 406 are all in fluid communication such that fluid can flow directly or pumped from one unit to the next via a series of fluid conduits. In other embodiments, one or more of the units 402, 404, and 406 may be independent from the others and fluid may be transferred to a surge drum or storage vessel and transferred from that vessel to the next unit.

As shown in FIG. 4, the vacuum distillation unit 402 is configured to receive crude petroleum feedstock. The vacuum distillation unit 402 distills the feedstock under vacuum at a selected cut temperature as discussed above. The vacuum distillation unit 402 produces one or several streams of distillate and vacuum residue.

The solvent deasphalting unit 404 is downstream of the vacuum distillation unit 402 and is configured to receive the vacuum residue as well as a deasphalting solvent (e.g., n-pentane). The vacuum residue and solvent mix together within the deasphalting unit 404 and are allowed to separate into a lighter phase (deasphalted oil) and a heavier phase (asphaltene-rich residue). In some embodiments, the solvent deasphalting unit 404 comprises a vessel configured for continuous deasphalting, as described above, and the vessel is sized such that the vertical velocity of the liquid inside the vessel is lower than the settling velocity of the solids. In other embodiments, the solvent deasphalting unit 404 comprises a vessel configured to allow the asphaltene rich phase to settle over time, followed by withdrawal of the liquid and solids, and the vessel may be any suitable size.

In some embodiments, the solvent deasphalting unit 404 further comprises one or more cyclones, centrifuges, and/or other enhanced gravity equipment to assist in separation of the solids from the liquid during the solvent deasphalting process.

In some embodiments, the system 400 further comprises a solvent removal/recovery unit (not shown), to remove solvent from the deasphalted oil. In some embodiments, the solvent recovery unit comprises an evaporator (e.g., a rotary evaporator). In other embodiments, the solvent recovery unit comprises a single or multi-stage flashing system, a distillation system, a supercritical separation system and/or any other suitable type of system, device or apparatus.

The mixing unit 406 is downstream of the solvent deasphalting unit 404 and is configured to receive both deasphalted oil from the solvent deasphalting unit 404 and vacuum residue from the vacuum distillation unit 402. The mixing unit 406 mixes the DAO and the vacuum residue to produce an asphalt binder blend. The mixing unit 406 may comprise any suitable mixing device including, but not limited to, a tumbler mixer, an agitator, a drum mixer, a ribbon mixer, a paddle mixer, in-line static mixer, in-line high shear mixer, colloid mill, or any other suitable mixing device.

Optionally, the system 400 may further comprise an oxidizer downstream of the vacuum distillation unit 402 configured to receive and oxidize the vacuum residue prior to the vacuum residue being sent to the solvent deasphalting unit 404.

Other variations are also possible. In other embodiments, the deasphalting process to produce the DAO used in asphalt binder production may be performed prior to vacuum distillation. For example, the partially deasphalted product of a paraffinic froth treatment process may be subjected to vacuum distillation to provide the DAO for use in the asphalt binder product. In these embodiments, the solvent deasphalting unit 404 would be upstream of the vacuum distillation unit 402 in the system 400 of FIG. 4.

Therefore, the methods 100, 200, and 300 and the system 400 allow for the production of asphalt binders of a wide variety of performance grades. The high and low temperature performance grades of the binders may be adjusted by at least one of: a) adjusting the viscosity/asphaltene content of the feedstock (e.g. by adjusting the distillation cut temperature during production of the feedstock or blending vacuum/flash residue with distillate to produce a desired cut); b) adjusting the solvent-to-feedstock ratio during the solvent deasphalting step; and c) adjusting the ratio of DAO to feedstock (if a blended asphalt binder is produced).

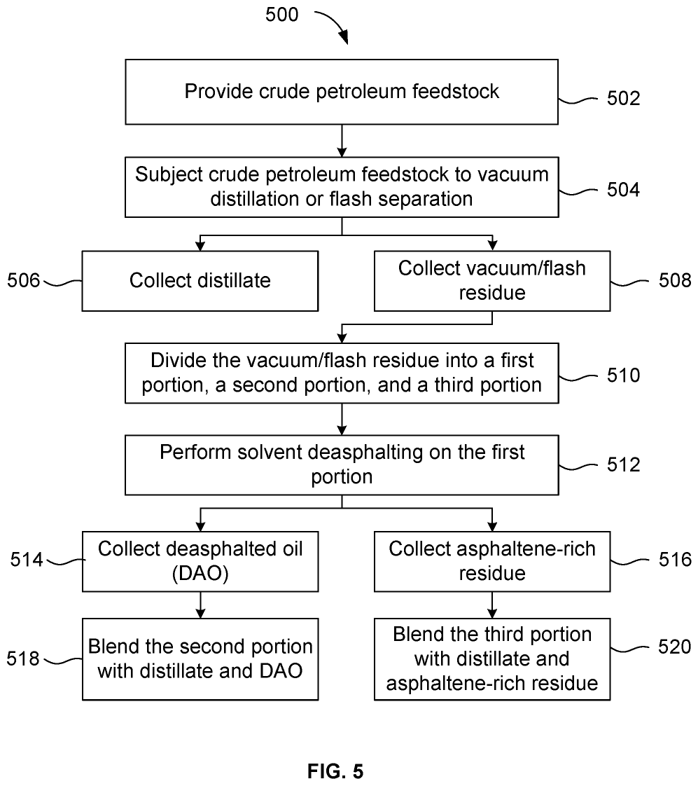

FIG. 5 is a flowchart of another example method for producing asphalt binders, according to some embodiments.

At block 502, a crude petroleum feedstock is provided. The crude petroleum feedstock may be any of the crude petroleum feedstocks described above. The feedstock may or may not be a high-asphaltene content feedstock.

At block 504, the crude petroleum feedstock is subjected to vacuum distillation. The vacuum distillation step can be done at various levels of vacuum and at various temperatures with or without the assistance of steam or inert gas as a stripping agent. Alternatively, the crude feedstock may be subjected to multistage flash separation at suitable temperatures and pressures.

At block 506, distillate is collected. It will be understood that the term “distillate” in this context is inclusive of both vacuum distillate and vaporized fractions of flash separation. Collecting the distillate may comprise collecting light distillate (LD) and heavy distillate (HD). Light distillate may be any fraction having an atmospheric equivalent boiling point range of less than about 350° C., less than about 400° C., less than about 420° C., or less than about 460° C. Heavy distillate may be distillate in the atmospheric equivalent boiling point range of between about 350° C. and about 550° C. or more specifically between about 400° C. and about 524° C. The heavy distillate may comprise vacuum gas oil or heavy vacuum gas oil. The light distillate may be used for other applications and the heavy distillate or a fraction thereof may be used to produce asphalt binders, as described below.

At block 508, residue is collected. It will be understood that the term “residue” in this context is inclusive of both vacuum residue and flash separation residue. The residue may be in the atmospheric equivalent boiling range greater than that of the heavy distillate, for example, greater than about 350° C., greater than about 400° C., greater than about 524° C., or greater than about 550° C.

At block 510, the vacuum/flash residue is divided into a first portion, a second portion, and a third portion. The first and second portion may each be any suitable percentage of the original residue. In some embodiments, the first portion may be mildly oxidized, as described above, prior to the deasphalting step at block 512.

At block 512, solvent deasphalting is performed on the first portion of the residue. The steps at block 512 may be similar to the steps at block 104 of the method 100, as described above. The solvent deasphalting step will produce a partially deasphalted oil (DAO) and an asphaltene-rich residue.

At block 514, the DAO is collected. The steps at block 514 may be similar to those at block 106 of the method 100, as described above. The collected DAO (initially diluted in solvent) may be sent to a solvent recovery unit to remove solvent therefrom.

At block 516, the asphaltene-rich residue is collected. The asphaltene-rich residue may be divided into a first portion and a second portion. The first portion may be sent directly to a solvent recovery unit to remove solvent therefrom and then dried. Hereafter, the desolvented and dried asphaltene-rich residue will be referred to as “dried deasphalter bottoms” (DAB). The DAB may be used to produce the asphalt binder, as discussed below. The second portion of the asphaltene-rich residue may be washed in a deasphalting solvent to remove residual deasphalted oil/bitumen and then sent to a solvent recovery unit to remove the solvent therefrom. The washed asphaltene solids may then be dried, thereby producing “washed and dried asphaltenes” (WDA). The recovered solvent from the asphaltene wash may be recycled and used in the solvent deasphalting step at block 512. The WDA may be used in asphalt binder production or may be used for other applications, such as carbon fiber production. The washing step helps to prepare the WDA for downstream processing. However, if all of the asphaltene-rich residue is to be used for asphalt binder production, then the washing step may be omitted and only DAB may be produced.

At block 518, the second portion of the vacuum/flash residue is blended with heavy distillate (HD) and DAO to produce a first blend. In some embodiments, the residue, HD, and DAO may be blended all at once. In other embodiments, the residue and DAO may be blended first, followed by addition of the HD (or vice versa).

At block 520, the third portion of the vacuum/flash residue is blended with heavy distillate (HD) and asphaltene-rich residue (i.e., DAB or WDA) to produce a second blend. The residue, HD, and DAB/WDA may be blended all at once or sequentially.

The ratio of vacuum/flash residue, HD, and DAO in the first blend may be selected to produce an asphalt binder having a desired grade with a desired high temperature and low temperature performance grade. For a given feedstock, measuring viscosity of each of the three streams and determining the correlation between the high and low failure temperatures of residue/HD and residue/DAO blends may be used to develop an empirical model to predict the performance grade of three-component blends based on their composition. For example, the viscosity of a blend of BVB with either HD or DAO at 135° C. can be predicted using the Viscosity Blending Index (VBI), measured dynamic viscosities of BVB, HD and/or DAO, and their composition. The High Temperature Grade (HTG) of binders tends to correlate relatively well with the viscosity at 135° C. An empirical correlation may be developed between the high temperature grade (HTG) and low temperature grade (LTG) of blends containing DAO based on experimental data. A similar correlation may be developed for blends containing HD. Therefore, by assuming blending in two stages (e.g., first blending BVB and DAO followed by addition of HD), the HTG and LTG of binders with specific compositions may be predicted. This type of a model can serve as a tool to guide the selection of composition of each component of the blend to achieve a desired grade of the binder product. The actual composition may then be confirmed by experimentation.

In some embodiments, the first blend comprises about 60 wt % to about 70 wt % vacuum/flash residue, between about 10 wt % and 20 wt % HD, and between about 15% and about 25% DAO.

The ratio of residue, HD, and DAB/WDA may also be selected to produce an asphalt binder having a desired grade with a desired high temperature and low temperature performance grade. In some embodiments, the amount of HD in the second blend is the total amount of HD remaining after production of the first blend and the amounts of residue and DAB/WDA are then selected based on the desired grade of the resulting asphalt binder. An empirical model may be used to predict the performance grade, as described above for the first blend.

In some embodiments, the second blend comprises about 40 wt % to about 50 wt % vacuum/flash residue, about 40 wt % to about 50 wt % HD, and about 5 wt % to about 15 wt % DAB/WDA. The composition of HD and DAB/WDA in the product are limited by colloidal stability of the produced blend and the possibility of phase separation of asphaltenes at certain compositions. Compositional analysis of the vacuum bottoms, heavy distillate, and deasphalted bottoms (e.g., determination of Saturates, Aromatic, Resins and Asphaltenes (SARA)) content may help determine the stability of target blends.

Therefore, in some embodiments, vacuum/flash residue, HD, and DAO may be used to produce a first asphalt binder and vacuum/flash residue, HD, and asphaltene-rich residue or WDA may be used to produce a second asphalt binder. In this example, the first asphalt binder may have a higher HTG, while the second asphalt binder may have a lower LTG. In other embodiments, the first and second asphalt binders may each have any desired performance grade and embodiments are not limited to the performance grades described herein. Moreover, it will be understood that various asphalt binders of varying grades may be produced by combining vacuum/flash residue, HD, and DAO, and by combining vacuum/flash residue, HD, and DAB/WDA, and thus embodiments are not limited to only producing two performance grades of asphalt binder. As only a fraction of the HD is used in the first asphalt binder, the remainder may be used in the second asphalt binder, thereby effectively using all of the HD produced by vacuum distillation or flash separation. Similarly, all of the vacuum/flash residue may be used in the asphalt binder blends or subjected to solvent deasphalting to produce DAO and DAB/WDA, which are also used in the blends. The remaining DAB/WDA not used for asphalt binder production may only be a small fraction of the total products and this fraction can be used for downstream applications (e.g., carbon fiber production). Thus, the method 500 may convert almost all of the crude petroleum feedstock to higher value products, with minimal remaining material that requires additional processing.

Put in another way, the method 500 uses both asphaltene content and distillate content as variables to adjust the grade of asphalt binders produced from any feedstock. Using two variables may add to the flexibility of asphalt binder production and broaden the range of achievable products. For example, the first asphalt binder blend in the example above is produced by adding a portion of HD to the vacuum/flash residue as well as by reducing the asphaltene content by addition of DAO. The addition of DAO may allow for production of asphalt binders having grades equivalent to asphalt binders produced by distillation at lower cut temperatures (or addition of larger amounts of HD). As noted above, the minimum distillation temperature is limited by certain performance requirements and, thus, reducing asphaltene content by addition of DAO can allow for distillation at higher temperatures. In addition, the amount of HD that can be produced from some feedstocks is limited (and/or it may be desired to use the HD for other blends) and, thus, reducing the asphaltene content may also lower the amount of HD required to achieve a desired grade.

Similarly, the second asphalt binder blend in the example above is produced by adding a portion of HD to the vacuum/flash residue and increasing asphaltene content by addition of DAB/WDA. The amount of HD in this second blend may be greater than that in the first blend. Increasing the asphaltene content by addition of DAB/WDA may help to achieve a higher HTG if the HTG of the residue/HD blend alone is too low. In some embodiments, the addition of DAB/WDA may allow for production of asphalt binders with greater temperature ranges than asphalt binders produced only by adjusting the distillation cut temperature or by blending HD and residue alone. In other words, increasing the asphaltene content tends to increase the high failure temperature more than it increases the low failure temperature. For example, if the HD/residue blend (without added DAB/WDA) meets a PG grade of 52-34 (temperature range of 86° C.) and DAB/WDA are added to increase the high failure temperature by 12° C. to 64° C., the low failure temperature may only increase by 6° C. to −28° C., leading to a PG grade of 64-28 (temperature range of 92° C.).

While producing both a first and second asphalt binder via the method 500 maximizes use of the crude petroleum feedstock, it will be understood that only the first or second asphalt binder may be produced if desired. In these embodiments, the remaining DAO and/or DAB/WDA may be used for other applications. In addition, although the method 500 describes blending residue with HD, it will be understood that, in other embodiments, adjusting the distillation cut temperature may produce a residue equivalent to an HD/residue blend. This residue can then be blended with DAO or DAB/WDA (and extra HD if needed) to achieve a variety of performance grades in a similar manner to the residue/HD/DAO and residue/HD/DAB or WDA blends.

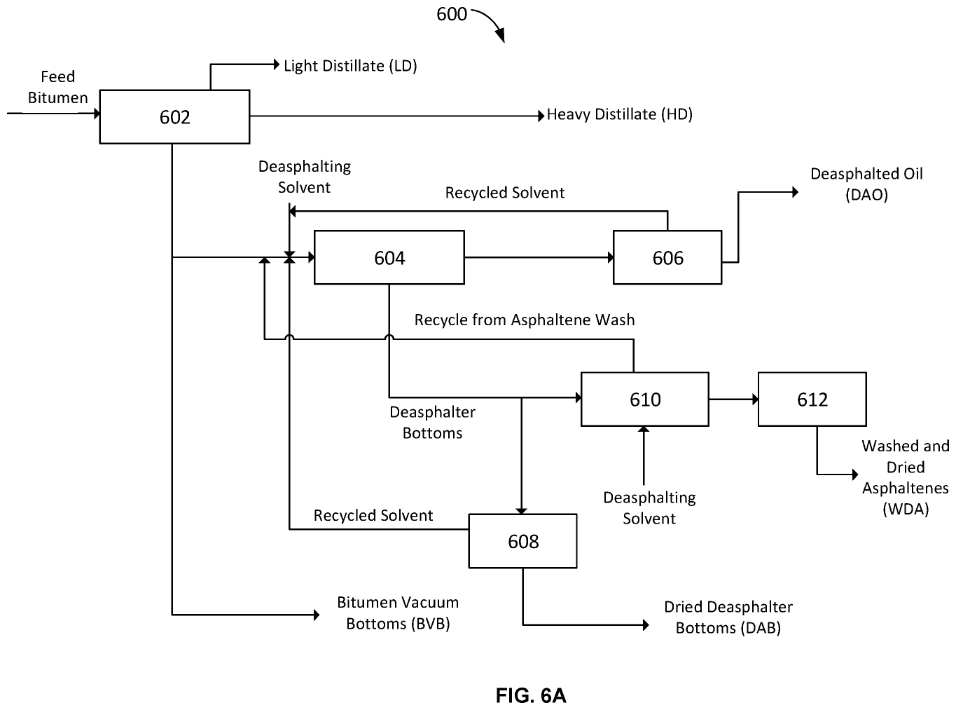

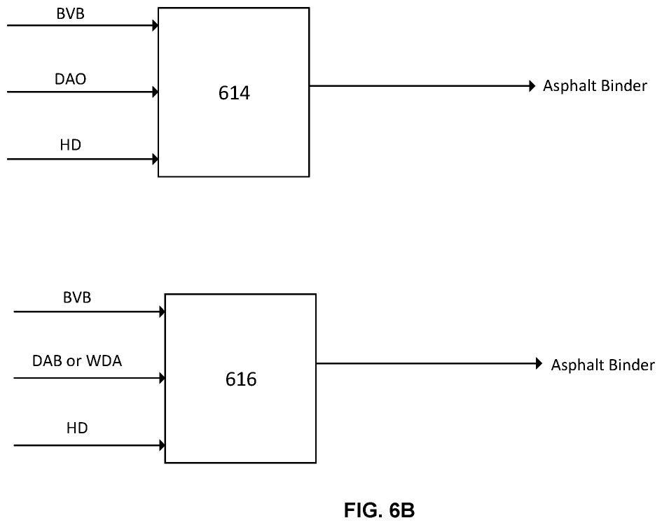

FIG. 6A is a functional block diagrams of an example system 600 that may implement the method 500 of FIG. 5. The system 600 is shown in FIG. 6A with bitumen as the crude petroleum feedstock; however, it is understood that the system 600 may be used with any other type of feedstock.

The system 600 in this embodiment comprises: a separation unit 602; a solvent deasphalting unit 604; first, second, and third solvent recovery units 606, 608, 612; and a washing unit 610. As shown in FIG. 6B, the system 600 may further comprise first and second mixing units 614, 616. The mixing units 614, 616 are shown as separate from the remainder of the system 600; however, it will be understood that any or all of the units of the system 600 may be in fluid communication with one another. Each unit may comprise one or more pieces of equipment.

The separation unit 602 may comprise a vacuum distillation unit, a multistage flash separation unit, or any other system or device capable of separating hydrocarbon materials into multiple fractions based on boiling point. The separation unit 602 is configured to receive the feed bitumen and generate light (low boiling) distillate, heavy (high boiling) distillate (HD), and vacuum/flash residue. In FIG. 6A and 6B, the residue is referred to as bitumen vacuum bottoms (BVB).

The solvent deasphalting unit 604 is downstream of the separation unit 602 and is configured to receive the BVB therefrom as well as receive a deasphalting solvent from a solvent tank (not shown). The solvent deasphalting unit 604 may be similar to the solvent deasphalting unit 404 of the system 400, as described above. The solvent deasphalting unit 604 produces deasphalted oil and deasphalter bottoms, both of which are diluted in solvent.

The solvent recovery units 606, 608, and 612 may each comprise an evaporator, a single or multi-stage flashing unit, a distillation unit, a supercritical separation unit, or any other suitable type of solvent removal device or system.

The first solvent recovery unit 606 is positioned downstream of the solvent deasphalting unit 604 and is configured to receive diluted deasphalted oil therefrom. The unit 606 removes solvent from the diluted deasphalted oil to produce the final deasphalted oil product (DAO).

The second solvent recovery unit 608 and the washing unit 610 are also positioned downstream of the solvent deasphalting unit 604 and are each configured to receive a respective stream of the diluted deasphalter bottoms therefrom. The solvent recovery unit 608 removes solvent from the diluted deasphalter bottoms to produce dried deasphalter bottoms (DAB).

The washing unit 610 is also configured to receive a deasphalting solvent from a solvent tank (not shown). The deasphalting solvent may be the same solvent used in the solvent deasphalting unit 604 or may be different. The washing unit 610 may be similar in structure to the deasphalting unit 604 or may be any other suitable structure to allow the deasphalter bottoms to mix together with the deasphalting solvent and settle into a lighter phase and a heavy, asphaltene-rich phase. The lighter phase may be recycled from the washing unit 610 into the solvent deasphalting unit 604, along with fresh deasphalting solvent. The asphaltene-rich phase may be sent to the third solvent recovery unit 612 to remove remaining solvent therefrom, thereby producing washed and dried asphaltenes (WDA).

The mixing units 614, 616 may each comprise any suitable mixing device including, but not limited to, a tumbler mixer, an agitator, a drum mixer, a ribbon mixer, a paddle mixer, in-line static mixer, in-line high shear mixer, colloid mill, or any other suitable mixing device.

The first mixing unit 614 is downstream of the separation unit 602 and the first solvent recovery unit 606 and is configured to receive BVB and HD from the separation unit 602 and DAO from the first solvent recovery unit 606. The mixing unit 614 mixes the BVB, HD and DAO to produce a first asphalt binder blend.

The second mixing unit 616 is downstream of the separation unit 602 and one or both of the second solvent recovery unit 608 and the third solvent recovery unit 612. The second mixing unit 616 is configured to receive BVB and HD from the separation unit 602 and DAB and/or WDA from the second and third solvent recovery units 608 and 612. The mixing unit 616 mixes the BVB, HD, and DAB or WDA to produce a second asphalt binder blend.

In other embodiments, the system 600 may further comprise additional mixing units to create additional blends. Alternatively, a single mixing unit may be provided and configured to receive different combinations of streams at different times to produce different blends.

In other embodiments, the system 600 may further comprise any other suitable equipment and may be in any other suitable configuration.

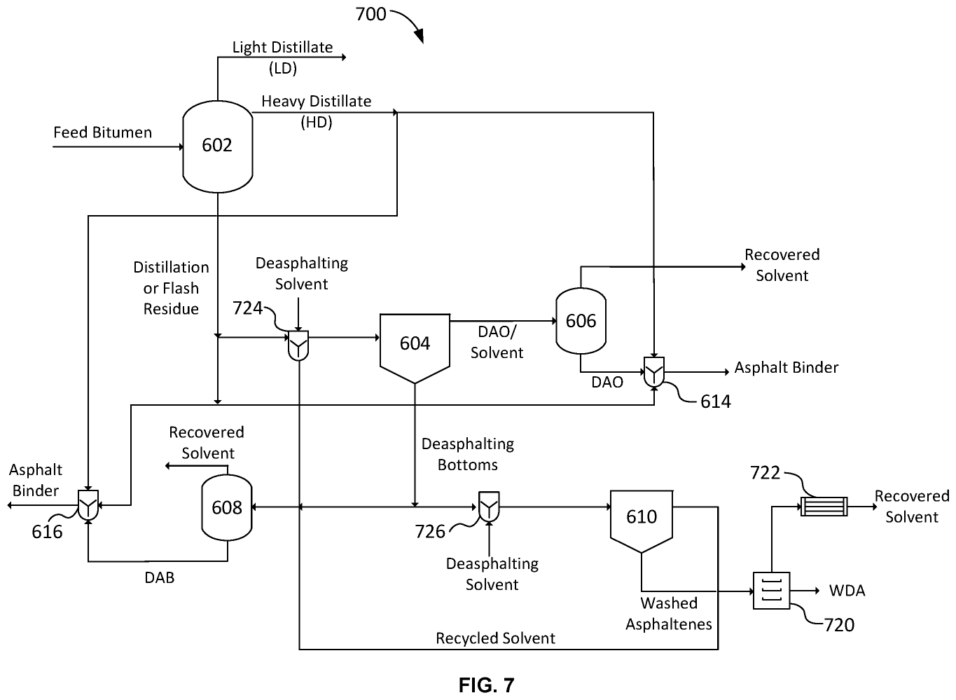

FIG. 7 is a functional block diagram of another example system 700 that may implement the method 500 of FIG. 5. The system 700 is shown with bitumen as the crude petroleum feedstock; however, it is understood that the system 700 may be used with any other type of feedstock.

The system 700 in FIG. 7 is similar in structure and function to the example system 600 of FIG. 6A and 6B and like reference numbers indicate like elements. In this embodiment, the mixers 614 and 616 are in fluid communication with the rest of the system 700. It is understood that there may be surge drums or storage vessels to which the product from each unit may be sent and from which each feedstock may be drawn.

The system 700 differs from the system 600 in that the third solvent recovery unit 612 is replaced with an asphaltene dryer 720 and a dryer condenser 722. The system 700 also includes third and fourth mixers 724 and 726. The third mixer 724 is in fluid communication with the separation unit 602, a deasphalting solvent tank (not shown), the solvent deasphalting unit 604, and the washing unit 610. The fourth mixer 726 is in fluid communication with the solvent deasphalting unit 604, the second solvent recovery unit 608, a deasphalting solvent tank (not shown) and the washing unit 610.

In operation, the separation unit 602 may receive a feedstock (e.g., feed bitumen in this embodiment) and separate the feedstock into light distillate (LD), heavy distillate (HD), and distillation or flash residue (e.g., BVB). The third mixing unit 724 receives the distillation or flash residue from the separation unit 602 and mixes it with deasphalting solvent from the solvent tank as well as recycled solvent from the washing unit 610. The mixture is then fed into the solvent deasphalting unit 604 to produce DAO and deasphalting bottoms (both of which are diluted in solvent). The DAO/solvent is fed into the first solvent recovery unit 606 to produce the final DAO as well as recovered solvent. The DAO is then mixed with HD and residue in the first mixing unit 614 to produce a first asphalt binder blend. Multiple binder blends with various grades with different ratios of DAO, HD and residue may be produced.

The fourth mixer 726 receives a portion of the deasphalter bottoms from the solvent deasphalting unit 604 and mixes it with deasphalting solvent. The mixture is then fed into the washing unit 610 to produce washed asphaltenes. Recycled solvent from the washing unit 610 can be fed back into the third mixing unit 724. The asphaltene dryer 720 dries the washed asphaltenes to produce washed and dried asphaltenes (WDA). The solvent removed from the washed asphaltenes is fed into the dryer condenser 722 to provide recovered solvent for recycling within the system 700 or for other uses.

The solvent recovery unit 608 may also receive a portion of the deasphalter bottoms from the deasphalting unit 604 and remove solvent therefrom to produce dried deasphalter bottoms (DAB). The DAB is then mixed with HD and residue to produce a second asphalt binder blend. Multiple binder blends with various grades with different ratios of DAB, HD and residue may be produced.

In other embodiments, the system 700 may further comprise any other suitable equipment and may be in any other suitable configuration.

Without any limitation to the foregoing, the systems and methods disclosed above are further described by way of the following examples.

### EXAMPLE 1—ASPHALT BINDER EXPERIMENTS

### 1.1 Feedstock Preparation

The crude petroleum feedstock used in the study was a SAGD-produced bitumen from the Athabasca region of Alberta, Canada. The oil was distilled under vacuum using ASTM test method D1160 at an atmospheric equivalent temperature of 525° C. It is noteworthy that the maximum temperature the bitumen is exposed to during vacuum distillation is 343° C.

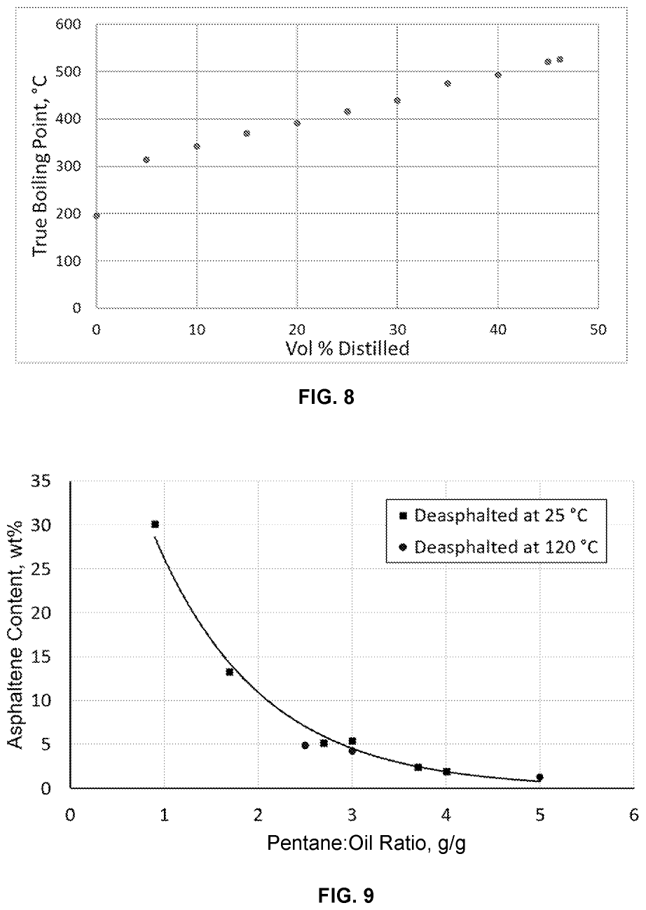

The vacuum distillation curve of the feed bitumen is provided in FIG. 8. The true boiling points are converted based on the still temperature under vacuum and the vacuum level. The residue of the vacuum distillation (the “bitumen vacuum bottoms” or “BVB”), accounting for 53.5±0.5 Vol% (56.5±0.5 wt %) of the original bitumen, was collected and used for preparation of asphalt binders as discussed below.

### 1.2 Solvent Deasphalting

The bitumen vacuum bottoms (BVB) recovered from distillation was mixed with 0.9 g to 5 g of n-pentane per g of BVB at room temperature or at 120° C. The mixture was stirred for 15 min at 600 rpm and left to settle overnight. The top liquid was then decanted and rotavapped to recover the solvent and produce the deasphalted oil (DAO). The C5 asphaltene contents of the DAO after solvent recovery were measured by mixing 40 ml of n-pentane per g of sample followed by filtration, drying and quantifying the precipitated asphaltene content. The bottom solids (asphaltenes) were washed several times by mixing with fresh pentane, settling and decantation of the top liquid.

The various DAO samples were mixed with the original BVB at varying ratios to obtain a final sample with the desired asphaltene content. The pure DAO and blended samples were identified as asphalt binders and analyzed for partial and full PG grade determination. The aging processes and analytical procedures performed on the asphalt binder samples are summarized in Table 1.

TABLE 1

| | | AASHTO | Sample | |
|---|---|---|---|---|
| Equipment | Temperature, ° C. | number | Type | Purpose |
| Rolling Thin | 163 | — | Original | Aging |
| Film Oven | | | binder | due to |
| (RTFO) | | | | volatilization |
| Pressure | 90 or 100 | — | RTFO | Aging |
| Aging Vessel | | | Residue | due to |
| (PAV) | | | | oxidation |
| Brookfield ™ | 135 | T316 | Original | High |
| Rotational | | | binder | temperature |
| Viscometer | | | | performance |
| Dynamic | 52 to 100 | T315 | Original | High |
| Shear | | | and RTFO | temperature |
| Rheometer | | | Residue | performance |
| Bending | 0 to −24 | T314 | PAV | Low |
| Beam | | | Residue | temperature |
| Rheometer | | | | performance |

AASHTO = American Association of State Highway and Transportation Officials

### Results and Discussion

The rate of rejection of asphaltenes from an oil sample mixed with an alkane solvent is correlated with the ratio of solvent to the original oil. Above the onset of asphaltene precipitation, higher solvent addition results in rejection of a larger fraction of asphaltenes. FIG. 9 shows the asphaltene content of the DAO from the deasphalting process plotted against the ratio of n-pentane to BVB (g of pentane to g of BVB) in the original mixture.

Overall, 11 samples of asphalt binders were prepared and analyzed to determine their performance grading. The results of the PG testing along with the asphaltene content and the BVB content are reported in Table 2. In Table 2: Original-1 and -2 are BVB without DAO addition; DAO-1 to -3 are pure DAO samples without blending (0% BVB); Blend-1 to -4 are room temperature DAO samples blended with varying ratios of BVB; HT Blend is a mixture of BVB with DAO produced (deasphalted) at 120 ° C.; and HT DAO is the pure DAO produced (deasphalted) at 120° C.

TABLE 2

| | Asphaltene | Official | Grade Temperature | | Range | |
|---|---|---|---|---|---|---|
| | Content, | PG | (GT), ° C. | | (High GT-- | % BVB |
| Sample | wt % | Grade | Low | High | Low GT), ° C. | in Blend |
| Original-1 | 30.4 | — | — | 98.0 | — | 100 |
| Original-2 | 30.1 | — | >−10 | — | — | 100 |
| DAO-1 | 4.5 | 52-16 | −20.2 | 57.5 | 77.7 | 0 |
| DAO-2 | Not | 52-22 | −23.0** | 55.7 | 78.8 | 0 |
| | measured | | | | | |
| DAO-3 | 1.4 | 52-22 | −24.2** | 53.2 | 77.4 | 0 |
| Blend-1 | 22.2 | 76-10 | −11.5 | 79.5 | 91.0 | 70 |
| Blend-2 | 20.3* | — | −14.2 | — | — | 60 |
| Blend-3 | 16.5 | 70-10 | <−10 | 73.2 | >84 | 35 |
| Blend-4 | 8.5* | — | −19.4 | — | — | 25 |
| Blend-5 | 14.8 | 70-10 | −15.1 | 71.2 | 86.3 | 45 |
| Blend-6 | 11.3 | 64-16 | −16.4 | 66.7 | 83.1 | 33 |
| HT Blend | 9.1 | 58-16 | −18.1 | 62.5 | 80.6 | 20 |
| HT DAO | 4.9 | 58-16 | −19.0 | 59.8 | 78.8 | 0 |

*Asphaltene content is calculated based on pentane asphaltene content of the components of the blend and the blending ratio.
**The aging process in the Pressure Aging Vessel (PAV) was performed at 90° C. as opposed to 100° C. for the rest of the samples.

The original BVB contained 30±0.5 wt % asphaltenes and had a high failure temperature of ˜100° C. which indicates very good performance at high temperatures. However, this sample failed the low temperature criteria even at the highest low testing temperature (equivalent of −10° C. failure temperature). Therefore, the original BVB was too brittle to be marketed as an asphalt binder without modification by, for example, adding some proportion of heavy distillate. All of the prepared samples containing >30% DAO met the elasticity criteria for low temperature performance grade at −10° C. and lower. The trends of high and low failure temperatures of the binders indicate that removal of asphaltenes decreases both the high failure temperature and low failure temperature of binders produced from BVB. The lowest temperature grade obtained by partial deasphalting of the 524° C.+fraction of the Athabasca bitumen sample was −24° C. (acceptable as −22° C. grade). Binders with acceptable performance at even lower temperatures may be obtained by distilling the bitumen sample at a lower temperature so that presence of a larger fraction of lighter components would also contribute to higher elasticity of the binder.

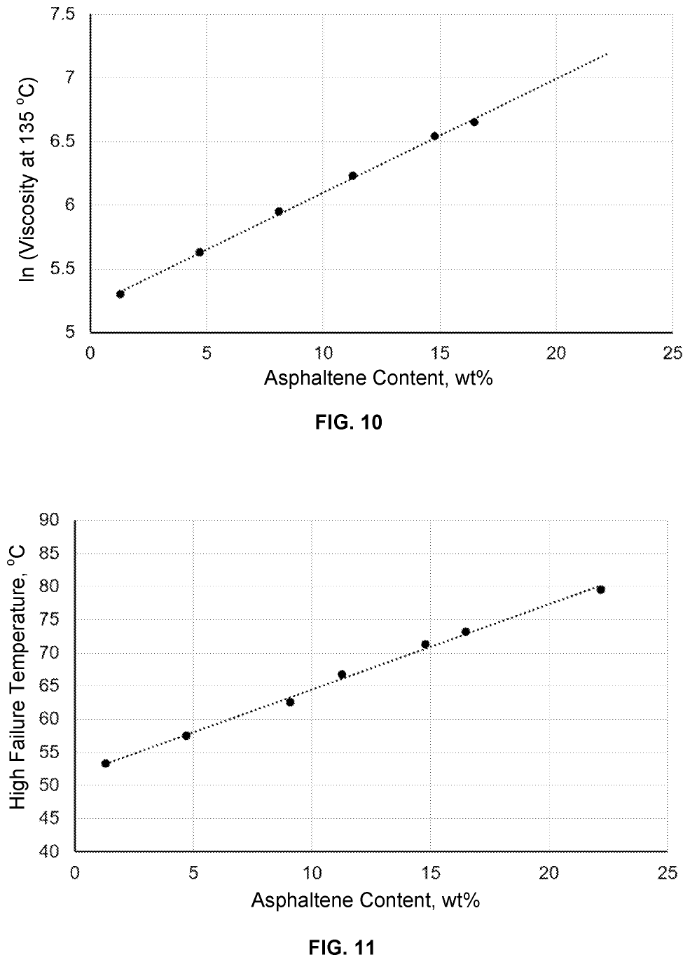

FIG. 10 shows the measured viscosities at 135° C. of selected binder samples from Table 2 plotted versus their asphaltene content. As shown in the figure, the viscosity increases exponentially, with the increase in asphaltene content.

The high failure temperature of an asphalt binder is indicative of its viscosity. Higher viscosity of the binder would result in the binder meeting performance criteria at higher temperatures. The high failure temperature of selected binder samples from Table 2 is plotted versus their asphaltene content in FIG. 11. As shown in the figure, the high temperature performance grade appears to be linearly correlated with the asphaltene content.

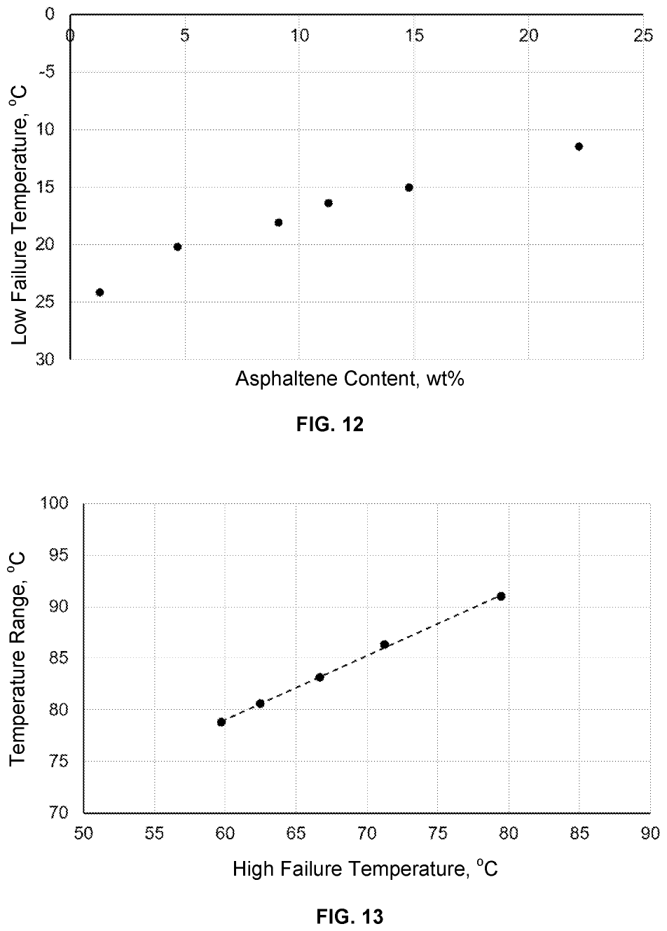

The low temperature performance grade of the binder is a more complex phenomenon representing the elasticity of the solidified binder at low temperatures. The results of low temperature testing of selected binder samples from Table 2 are plotted versus their asphaltene content in FIG. 12. While, overall, the low failure temperature tends to decrease with decreasing asphaltene content in the sample, the behavior was found to deviate from a linear trend.

FIG. 13 shows the temperature ranges (high failure temperature minus low failure temperature) for selected binder samples from Table 2 plotted versus their high failure temperature. Generally, temperature range increases with increasing high failure temperature.

In this Example, three major performance grades of asphalt binders were consistently and repeatably produced through partial deasphalting and blending of bitumen vacuum bottoms distilled at an atmospheric equivalent temperature of 524° C.: 76-10, 58-16 and 52-22.

### EXAMPLE 2—ASPHALT BINDER EXPERIMENTS WITH DISTILLATE BLENDS

Various asphalt binder blends were produced using Athabasca bitumen vacuum bottoms distilled at atmospheric equivalent temperature of 524° C. (BVB), heavy distillate in the boiling range of 420-524° C. (HD), and deasphalted oil (DAO) and washed asphaltenes (WDA) produced from solvent deasphalting of BVB at an n-pentane to BVB ratio of 5:1. These components were blended at various ratios and tested to determine their performance grade. All the blends in the following table met the criteria required by AASHTO for performance grade binders.

TABLE 3

| | | | | | | | Range | Flash |
|---|---|---|---|---|---|---|---|---|
| | BVB¹ | HD² | DAO³ | WDA⁴ | HTG⁵ | LTG⁶ | (LTG-HTG) | Point |
| Sample | wt % | wt % | wt % | wt % | ° C. | ° C. | ° C. | ° C. |
| DAO Blend-1 | 70 | 0 | 30 | 0 | 79.5 | −11.5 | 91.0 | >350 |
| DAO Blend-2 | 45 | 0 | 55 | 0 | 71.2 | −15.1 | 86.3 | >330 |
| DAO Blend-3 | 33 | 0 | 67 | 0 | 66.7 | −16.4 | 83.1 | — |
| DAO Blend-4 | 25 | 0 | 75 | 0 | 62.5 | −18.1 | 80.6 | — |
| HD Blend -1 | 90.1 | 9.9 | 0 | 0 | 83.8 | −10.8 | 94.6 | >300 |
| HD Blend -2 | 78.3 | 21.7 | 0 | 0 | 69.6 | −20.3 | 89.9 | >290 |
| HD Blend -3 | 67 | 33 | 0 | 0 | 54.5 | −28.3⁷ | 82.8 | — |
| DAO + HD | 67 | 10.5 | 22.5 | 0 | 71.1 | −18.2 | 89.3 | — |
| Blend - 1 | | | | | | | | |
| DAO + HD | 65.6 | 18 | 16.4 | 0 | 64.4 | −21.7 | 86.1 | — |
| Blend - 2 | | | | | | | | |
| WDA + HD | 43.5 | 43.5 | 0 | 13 | 55.7 | −32.1⁷ | 87.8 | 264 |
| Blend - 1 | | | | | | | | |
| WDA + HD | 59.3 | 29.7 | 0 | 11 | 72.3 | −21.9 | 94.2 | — |
| Blend - 2 | | | | | | | | |

¹Distilled at atmospheric equivalent temperature of 524° C.
²Distillate collected between atmospheric equivalent temperatures of 420 and 524° C.
³524° C. + BVB deasphalted at solvent-to-bitumen ratio of 4:1 (wt/wt) with residual pentane asphaltene content of 2 ± 0.5 wt %.
⁴Asphaltenes collected from deasphalting of 524° C. + BVB at solvent-to-bitumen ratio of 4:1 (wt/wt) washed with 10:1 ratio of pentane and dried.
⁵High Temperature Grade.
⁶Low Temperature Grade.
⁷For binders with a high temperature grade lower than 58° C., the aging process in the Pressure Aging Vessel is typically performed at 90° C. However, all the samples for which the results are reported in Table 3 are aged at 100° C. for ease of comparison. The actual LTG for HD Blend-3 and WDA + HD Blend-1 is expected to be lower than the reported value.

### EXAMPLE 3—PERFORMANCE GRADES OF ASPHALT BINDERS PRODUCED IN EXAMPLES 1 AND 2 FROM ATHABASCA BITUMEN

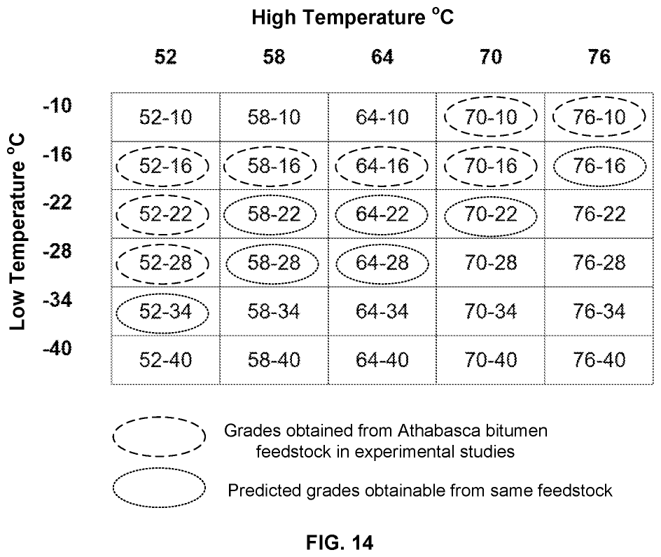

FIG. 14 is a grid matrix of the most common performance grades of asphalt binder marketed around the world. The horizontal axis shows the maximum temperature that the pavement is exposed to during the year and the vertical axis represents the minimum temperature values. Performance grades of the asphalt binders produced in Examples 1 and 2 are circled in the grid of FIG. 14. Additional performance grades would be obtainable from the same feedstock by adjusting at least one of: the solvent-to-bitumen ratio during solvent deasphalting; the proportions of BVB, HD, DAO, and/or WDA in the blends; and/or the vacuum distillation conditions used to produce the BVB and HD. Grades expected to be obtainable from the same bitumen feedstock are also indicated on FIG. 14.

### EXAMPLE 4—EXAMPLES OF PRODUCTION OF TWO DIFFERENT BINDER GRADES FROM ATHABASCA BITUMEN

Based on the results of Example 2, two binder graders (PG 64-22 and PG 52-34) may be produced from Athabasca bitumen as outlined in Table 4:

TABLE 4

| | PG 64-22 | PG 52-34 |
|---|---|---|
| | (kg) | (kg) |
| BVB | 449 | 150 |
| DAO | 109 | 0 |
| Heavy Distillate | 122 | 150 |
| Asphaltenes (DAB or WDA) | 0 | 24 |
| Total Amount of Binder Produced | 680 | 320 |

The amount of heavy distillate in the PG 64-22 is selected to produce 1000 kg (1 tonne) of total binder. The PG 52-34 binder uses the remaining distillate not used to produce the PG 64-22 binder. 20 kg of asphaltenes (˜2% of the total binders produced) may be rejected in the process. These asphaltenes can be used for other purposes such as carbon fiber production.

Alternatively, PG 70-16 and PG 52-34 binders can be produced as outlined in Table 5:

TABLE 5

| | PG 70-16 | PG 52-34 |
|---|---|---|
| | (kg) | (kg) |
| BVB | 350 | 228 |
| DAO | 117 | 0 |
| Heavy Distillate | 41 | 228 |
| Asphaltenes (DAB or WDA) | 0 | 40 |
| Total Amount of Binder Produced | 508 | 492 |

The amount of heavy distillate in the PG 70-16 is selected to produce 1000 kg (1 tonne) of total binder. The PG 52-34 binder uses the remaining distillate not used to produce the PG 70-16 binder. 6 kg of asphaltenes (˜0.6% of the total binders produced) may be rejected in the process. These asphaltenes can be used for other purposes such as carbon fiber production.

### EXAMPLE 5—ASPHALT BINDER PRODUCTION FROM HEAVY OIL FEEDSTOCK BLEND PREPARATION

Heavy oil (HO) containing diluent was distilled to 504° C. and the distillate from 460-504° C. as well as the vacuum bottoms (VB) (504° C.+) were collected separately. The yield of residue and distillate were 45 wt % and 13.1 wt % respectively (on a diluent free basis).

Seven asphalt binder samples were prepared: the as-prepared vacuum bottoms (HO VB); two blends of 460-504° C. distillate with VB (HO Dist Blend 1 and 2); two blends of DAO with VB (HO DAO Blend 1 and 2); and two blends of VB with distillate and added asphaltenes (HO Dist+Asph 1 and 2). The asphaltenes were obtained from a deasphalting process at 4:1 pentane to VB ratio. The asphaltenes were not washed after settling and were used as-is. The asphaltene fraction is expected to have 20-30% residual deasphalted oil therein.

The composition of the seven samples and their final C5 asphaltene content are reported in Table 6 below. The asphaltene contents of the samples were measured using internal methods of InnoTech Alberta Inc.

TABLE 6

| | | | | | Added |
|---|---|---|---|---|---|
| | Asphaltene | | | | Asphaltene |
| | Content | VB | Distillate | DAO | Fraction |
| Sample | (wt %) | (wt %) | (wt %) | (wt %) | (wt %) |
| HO VB | 36.1 | 100 | — | — | — |
| HO Dist | 30.3 | 82.8 | 17.2 | — | — |
| Blend 1 | | | | | |
| HO Dist | 24.7 | 70.8 | 29.2 | — | — |
| Blend 2 | | | | | |
| HO DAO | 26.1 | 67.0 | — | 33.0 | — |
| Blend 1 | | | | | |
| HO DAO | 18.5 | 48.0 | — | 52.0 | — |
| Blend 2 | | | | | |
| HO Dist + | 26.7 | 57.9 | 32.0 | —* | 10.1 |
| Asph 1 | | | | | |
| HO Dist + | 31.9 | 34.3 | 44.0 | —* | 21.7 |
| Asph 2 | | | | | |

*No DAO was added but the added asphaltene fraction is expected to contain ~20-30% residual deasphalted oil.

### Results and Discussion

The prepared asphalt binder blends were subjected to full AASHTO M320 performance grade determination analysis. The performance grades obtained in the analyses for each sample are tabulated in Table 7 below.

TABLE 7

| | Asphaltene | Official | Failure Temperature | | Range (High |
|---|---|---|---|---|---|
| | Content | PG | (FT), (° C.) | | FT - Low |
| Sample | (wt %) | Grade | Low | High | FT), (° C.) |
| HO VB | 36.1 | N/A | −8.2 | 92.3 | 100.5 |
| HO Dist | 30.3 | 70-22 | −23.2 | 73.1 | 96.3 |
| Blend 1 | | | | | |
| HO Dist | 24.7 | 58-34 | −34.1 | 58.3 | 92.4 |
| Blend 2 | | | | | |
| HO DAO | 26.1 | 70-16 | −20.2 | 74.0 | 94.2 |
| Blend 1 | | | | | |
| HO DAO | 18.5 | 64-22 | −24.2 | 64.2 | 88.3 |
| Blend 2 | | | | | |
| HO Dist + | 26.7 | 64-28 | −29.8 | 65.1 | 95.0 |
| Asph 1 | | | | | |
| HO Dist + | 31.9 | 70-22 | −26.1 | 73.6 | 99.6 |
| Asph 2 | | | | | |

All blended samples met the aging and physical property requirements for use as asphalt binders. The original vacuum bottoms (HO VB) did not meet any performance grade requirement as their low temperature grade was higher than the −10° C. minimum for common asphalt binder grades.

The trends of changes in high and low temperature grading of these binders with distillate and asphaltene contents are similar to those observed for Athabasca bitumen-based binders. However, the binder grades produced from this heavy oil consistently have a larger temperature range at the same high temperature grade compared to bitumen-based binders.

The two distillate blends (HO Dist Blend 1 and 2) represent binder grades that can be produced by distillation. Both blends met the requirements for high-quality asphalt binders with the range between the high and low failure temperatures being above 92° C. While the HO Dist Blend 2 results are marginal for meeting a 58-34 grade, distillation of the feedstock is expected to reliably produce a PG 58-31 binder, which is one of the most common grades in Alberta.

Although the quality of the binders prepared by blending the vacuum bottoms with deasphalted oil (HO DAO Blend 1 and 2) was lower than the distillate containing blends (a trend also observed for bitumen-based binders) the samples still meet the requirements for widely marketable asphalt binders. Based on the results with simple blending of DAO and VB (without the need for any distillate), a 70-22 superior grade is obtainable. DAO Blend 2 met requirements for a 64-22 grade, which is the most common grade in the North American market.

As was the case for bitumen-based binders, addition of asphaltenes improved the performance (i.e., temperature range) of the HO Dist+Asph binders over the distillation-based binders. Based on the results in Table 7 above, we expect high value binder grades such as PG 70-28, 58-34, 64-31 and 52-37 to be readily produced by adjusting the blending ratio of the three components when asphaltenes are used as an additive. Furthermore, these experiments confirmed that extra washing steps are not necessarily required for the asphaltenes obtained from the deasphalting process if they are to be used for blending into a binder product.

Although particular embodiments have been shown and described, it will be appreciated by those skilled in the art that various changes and modifications might be made without departing from the scope of the disclosure. The terms and expressions used in the preceding specification have been used herein as terms of description and not of limitation, and there is no intention in the use of such terms and expressions of excluding equivalents of the features shown and described or portions thereof. Moreover, in interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

1. A method for producing an asphalt binder, comprising:
providing a high-asphaltene content petroleum feedstock;
performing solvent deasphalting on the high-asphaltene content petroleum feedstock to produce a partially deasphalted oil and an asphaltene-rich residue; and
collecting the partially deasphalted oil for use in the asphalt binder, wherein the asphalt binder at least partially comprises the partially deasphalted oil.

2. The method of claim 1, further comprising:
dividing the high-asphaltene content petroleum feedstock into a first portion and a second portion, wherein the solvent deasphalting is performed on the first portion to produce the partially deasphalted oil; and
blending the partially deasphalted oil with the second portion of the feedstock to produce the asphalt binder.

3. The method of claim 2, wherein the partially deasphalted oil is blended with the second portion of the feedstock such that the asphalt binder comprises between about 10% and about 90% partially deasphalted oil.

4. The method of claim 1, wherein the high-asphaltene content petroleum feedstock comprises residue from vacuum distillation or flash separation of a crude petroleum feedstock.

5. The method of claim 1, wherein providing the high-asphaltene content petroleum feedstock comprises:
providing a crude petroleum feedstock;
selecting a vacuum distillation cut temperature for a vacuum residue based on a desired viscosity of the vacuum residue;
subjecting the crude petroleum feedstock to vacuum distillation at the selected vacuum distillation cut temperature; and
collecting the vacuum residue for use as the high-asphaltene content petroleum feedstock.

6. The method of claim 5, wherein the selected vacuum distillation cut temperature is an atmospheric equivalent temperature of between about 400° C. and about 550° C.

7. The method of claim 5, further comprising blending the vacuum residue with a heavy distillate to adjust the viscosity of the vacuum residue.

8. The method of claim 5, wherein the crude petroleum feedstock comprises bitumen or extra heavy oil.

9. The method of claim 5, wherein the crude petroleum feedstock comprises recycled asphalt.

10. The method of claim 1, further comprising collecting a fraction of the asphaltene-rich residue for use in carbon fiber production.

11. A method for producing an asphalt binder, comprising:
providing a crude petroleum feedstock;
subjecting the crude petroleum feedstock to vacuum distillation or flash separation to produce a heavy distillate and a residue;
dividing the residue into a first portion and a second portion;
performing solvent deasphalting on the first portion of the residue to produce a partially deasphalted oil and an asphaltene-rich residue; and
blending the second portion of the residue with the heavy distillate and one of the partially deasphalted oil and the asphaltene-rich residue.

12. The method of claim 11, wherein the heavy distillate has an atmospheric equivalent boiling temperature between about 350° C. and about 550° C. and the residue has an atmospheric equivalent boiling temperature greater than the heavy distillate.

13. The method of claim 11, further comprising selecting a composition of the asphalt binder to achieve a desired grade using an empirical model that predicts high temperature grade and low temperature grade based on: measuring viscosities of each of the residue, the heavy distillate, and at least one of the partially deasphalted oil and the asphaltene-rich residue;
correlating the measured viscosities with the high temperature grade for a given blend; and
correlating the high temperature grade with the low temperature grade.

14. The method of claim 11, wherein the residue is further divided into a third portion, and wherein the blending step comprises:
blending the second portion of the residue with a first portion of the heavy distillate and the partially deasphalted oil to produce a first asphalt binder; and
blending the third portion of the residue with a second portion of the heavy distillate and the asphaltene-rich residue to produce a second asphalt binder.

15. The method of claim 11, wherein the crude petroleum feedstock comprises bitumen or extra heavy oil.

16. The method of claim 11, wherein the crude petroleum feedstock comprises recycled asphalt.

17. The method of claim 11, further comprising collecting a fraction of the asphaltene-rich residue for use in carbon fiber production.

18. An asphalt binder comprising:
a first portion of a residue produced by vacuum distillation or flash separation of a crude petroleum feedstock;
a heavy distillate produced by the vacuum distillation or flash separation of the crude petroleum feedstock; and
a partially deasphalted oil or an asphaltene-rich residue produced by solvent deasphalting of a second portion of the residue.

19. The asphalt binder of claim 18, wherein the crude petroleum feedstock comprises bitumen or extra heavy oil.

20. The asphalt binder of claim 18, wherein the crude petroleum feedstock comprises recycled asphalt.
